(19) United States
(12) Patent Application Publication
(10) Pub. No.: US 2010/0151430 A1
(43) Pub. Date: Jun. 17, 2010

(54) Identifying a body shape

(75) Inventor: Kathleen Jones, Surrey (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Kit Jones Consulting Limited

(21) Appl. No.: 12/316,580

(22) Filed: Dec. 12, 2008

(51) Int. Cl. G06F 19/00

(52) U.S. Cl. 434/322

(57) ABSTRACT

A method which comprises presenting a first question which prompts a user to compare width of shoulders and width of hips, receiving an answer to the first question, presenting a second question in dependence upon the answer to the first question, receiving an answer to the second question, identifying a body shape in dependence upon at least the answers to the first and second questions and storing a body shape identifier corresponding to the body shape.

### FIELD OF THE INVENTION

The present invention relates to a method of and apparatus for identifying a body shape.

### BACKGROUND

Purchasing garments (herein also referred to as “clothes”) online or in store can be an onerous and time-consuming task for consumers (or “customers”). Garment sizes, such as women's dress sizes, tend to lack uniformity even for garments offered for sale by the same retailer.

WO-A-2008033138 describes a method and system for specifying the fit of garments and matching the fit of individual garments to individual consumers. This includes categorizing human body shapes based on dimensional and demographic body measurement data sampled from the human population, and statistically analyzing the measurement data to determine the appropriate number of discrete body shapes, as well as the range of measurement values characteristic of each body shape. The method includes assigning a shape code to each body shape which is a unique name, symbol or curve representing that shape. A recommendation engine can be employed to specify and match the fit of individual garments to individual consumers.

US-A-2002138170 describes a system for determining the most appropriate fit and size of a garment, based on customer preference or objective criteria, for a set of garment dimensions as they relate to a set of consumer body dimensions and a set of ideal body dimensions for that garment or for a range of garments.

Categorizing body shapes and allowing customers to identify their body shape can help them to select and purchase satisfactory garments.

On-line stores, such as Littlewoods Direct (www.littlewoodsdirect.com) can help a customer to identify their body shape by completing a questionnaire and using the body shape to find garments for the customer which compliment their shape. The customer is asked to answer ten subjective questions, each of apparently equal importance. Due to the number and the manner of presentation of these questions, the customer may not give each question enough thought, may not provide the best answer and/or may pick a ‘safe’, but incorrect answer, for example by selecting “average size”. Thus, they may arrive at a body shape which is not representative of their true body shape.

Fewer questions can be presented, for example as used in Gok's Style Consultation which available via the Channel 4 website (gok.channel4.com). However, this categorisation process still presents questions of apparently equal importance. This and other drawbacks can lead to the user being presented with an unrepresentative body shape.

### SUMMARY

According to a first aspect of certain embodiments of the present invention there is provided a method comprising presenting a first question which prompts a user to compare width of shoulders and width of hips, receiving an answer to the first question, presenting a second question in dependence upon the answer to the first question, receiving an answer to the second question, identifying a body shape in dependence upon at least the answers to the first and second questions and storing a body shape identifier corresponding to the body shape.

This can provide a simpler and/or more accurate way of identifying a body shape for a user purchasing garments online or in store. Furthermore, using a comparison, particularly for the first question, can help the user to answer the question more r truthfully and reliably. Not all the questions need involve comparing sizes of different parts of the body.

Presenting the first question may comprise displaying a first page which includes the first question and wherein presenting the second question may comprise displaying a second, different page which includes the second question. The method may comprise presenting an image of a body shape with the first question and, in response to receiving the answer to the first question, presenting a revised image of the body shape reflecting the answer. This can help the user to answer the question correctly. The method may comprise prompting the user to confirm their answer or to continue before presenting the second question.

The user may be presented with no more than two or three questions. Fewer questions can help the user to think about the answers they give. The user may also be asked for one or more measurements.

The method may further comprise, in response to determining that the width of the shoulders is about the same as the width of the hips, obtaining a value of shoulder width or shoulder circumference, comparing the value with a corresponding predefined value so as to determine whether the shoulders are broad or narrow and choosing the second question in dependence upon whether the shoulders are broad or narrow.

Presenting the second question may comprise, in response to determining that the shoulders are narrow, prompting the user to judge an approximate size of a breast, wherein identifying the body shape includes determining the body shape in dependence upon size of breast. The method may further comprise, in response to. receiving an answer that the breast is small, identifying the body shape. The method may further comprise, in response to receiving an answer that the breast is at least average size, determining height of a waist relative to a belly button, wherein identifying the body shape includes determining the body shape in dependence upon the height of the waist. The method may further comprise receiving a value of the height of a waist relative to a belly button from the user. The method may further comprise, in response to determining height of the waist relative to the belly button, identifying the body shape.

Presenting the second question may comprise, in response to determining that the shoulders are broad, prompting the user to judge curvature of waist, wherein identifying the body shape includes determining the body shape in dependence upon the curvature of a waist. The method may further comprise, in response to receiving an answer that the waist is straight, identifying the body shape. The method may further comprise, in response to receiving an answer that the waist curves outwards, identifying the body shape. The method may further comprise, in response to receiving an answer that the waist curves inwards and is well defined, determining height of waist relative to belly button, wherein identifying the body shape includes determining the body shape in dependence upon the height of waist. The method may further comprise, in response to determining height of the waist relative to the belly button, identifying the body shape. The method may further comprise, in response to receiving an answer that the waist curves gently inwards, determining height of waist relative to belly button, wherein identifying the body shape includes determining the body shape in dependence upon the height of waist. The method may further comprise, in response to determining that the waist is no more than a predefined height above the belly button, presenting a third question to the user which prompts the user to judge a size of thigh and receiving an answer to the third question, wherein identifying the body shape includes determining the body shape in dependence upon the answer to the third question.

The method may further comprise, in response to determining whether the shoulders are narrower than the hips, determining a height of waist relative to a belly button, wherein identifying the body shape includes determining the body shape in dependence upon the height of waist. The method may further comprise, in response to determining that the waist is no more than a predefined height above the belly button, prompting the user to judge curvature of waist and determining curvature of waist, wherein identifying the body shape includes determining the body shape in dependence upon the curvature of a waist. The method may further comprise, in response to determining that the waist curves inwards, presenting a third question to the user which prompts the user to judge a size of breastand receiving an answer to the third question, wherein identifying the body shape includes determining the body shape in dependence upon the answer to the third question.

The method may comprise, in response to determining whether the shoulders are broader than the hips, prompting the user to judge an approximate size of a breast, wherein identifying the body shape includes determining the body shape in dependence upon size of breast.

The method may further comprise comparing height of a subject to a predetermined height and, in dependence upon the height falling below the predetermined height, identifying whether the subject is petite and storing a modifier indicative of height.

The method may comprise receiving a value for each of a plurality of different body measurements, wherein identifying the body shape comprises determining the body shape in dependence upon the result of the comparison and at least one body measurement.

Identifying the body shape may comprise identifying a body shape of a woman, man, girl or boy.

The method may further comprise displaying a representation and/or description of the body shape.

The method may further comprise offering garments for sale based upon the body shape.

The method may comprise receiving a list of preferences relating to garments and may further comprise offering garments for sale also based on the preferences.

According to a second aspect of the some embodiments of the present invention there is provided a computer program product comprising a computer readable medium storing a computer program comprising instructions for performing the method.

According to a third aspect of the some embodiments of the present invention there is provided apparatus comprising at least one processor and memory, the processor configured to present a first question which prompts a user to compare width of shoulders and width of hips, to receive an answer to the first question, to present a second question in dependence upon the answer to the first question, to receive an answer to the second question, to identify a body shape in dependence upon the answers to the first and second questions, and to store, in memory, a body shape identifier corresponding to the body shape.

According to a fourth aspect of the some embodiments of the present invention there is provided apparatus comprising means for presenting a first question which prompts a user to compare width of shoulders and width of hips, means for receiving an answer to the first question, means for presenting a second question in dependence upon the answer to the first question, means for receiving an answer to the second question, means for identifying a body shape in dependence upon the answers to the first and second questions and means for storing a body shape identifier corresponding to the body shape.

According to a fifth aspect of some embodiments of the present invention there is provided a method comprising, in response to identifying a subject, obtaining at least one profile for the subject which comprises criteria for selecting garments and displaying item(s) for selection by a prospective purchaser in dependence upon said at least one profile.

Thus, a purchaser can buy a gift for the subject which the user is more likely to want to keep.

The at least one profile may include a body shape identifier corresponding to the body shape of the subject.

The method may further comprise receiving instructions selecting at least one of the item(s) for purchase.

The at least one profile may be configured such that details included in the at least one profile are not accessible by a purchaser.

According to a sixth aspect of the some embodiments of the present invention there is provided a computer program product comprising a computer readable medium storing a computer program comprising instructions for performing the method.

According to a seventh aspect of the some embodiments of the present invention there is provided apparatus comprising at least one processor and memory, the processor configured, in response to identifying a subject, to obtain at least one profile for the subject which comprises criteria for selecting garments and to display item(s) for selection by a prospective purchaser in dependence upon said at least one profile.

According to an eighth aspect of the some embodiments of the present invention there is provided apparatus comprising means, in response to identifying a subject, for obtaining at least one profile for the subject which comprises criteria for selecting garments and means for displaying item(s) for selection by a prospective purchaser in dependence upon said at least one profile.

### BRIEF DESCRIPTION OF THE DRAWINGS

Certain embodiments of the present invention will now be described by reference to the accompanying drawings in which:

FIG. 1 is a schematic diagram of a system for allowing a user to identify their body shape and to purchase garments from a retailer either on-line or in store;

FIG. 2 is a schematic diagram of a customer database;

FIG. 3 is a schematic diagram of a body shape profile;

FIGS. 4a and 4b illustrate short and long waists respectively;

FIG. 5 is a schematic diagram of a body size profile;

FIG. 6 is a schematic diagram of a customer preference profile;

FIG. 7 is a schematic diagram of a garment database;

FIG. 8 is a schematic diagram of a computer system;

FIG. 9 is a process flow diagram of a method of categorizing garments;

FIG. 10 is a process flow diagram of a method of categorizing body shapes;

FIG. 11a illustrates a first web page for providing body measurements;

FIG. 11a illustrates a second web page for providing body measurements;

FIG. 12a illustrates a third web page for answering questions relating to body shape;

FIG. 12b illustrates how the third web page shown in FIG. 12a is modified in response to providing a first answer to a question;

FIG. 12c illustrates how the third web page shown in FIG. 12a is modified in response to providing a second answer to a question;

FIG. 12d illustrates how the third web page shown in FIG. 12a is modified in response to providing a third answer to a question;

FIG. 12e illustrates a page reporting a body shape to a user;

FIG. 13 illustrates a table of different body shapes;

FIG. 14 illustrates different body shapes;

FIGS. 15a to 15f is a process flow diagram of a method of categorizing body shapes using questions;

FIG. 16 is a process flow diagram of a method of obtaining size measurements;

FIG. 17 illustrates a table of size measurements;

FIG. 18 is a process flow diagram of a method of obtaining customer preferences;

FIGS. 19a and 19b is a process flow diagram of a method of searching a garment database; and

FIG. 20 is a process flow diagram of a method of setting up a gift advisory service.

### DETAILED DESCRIPTION OF CERTAIN EMBODIMENTS

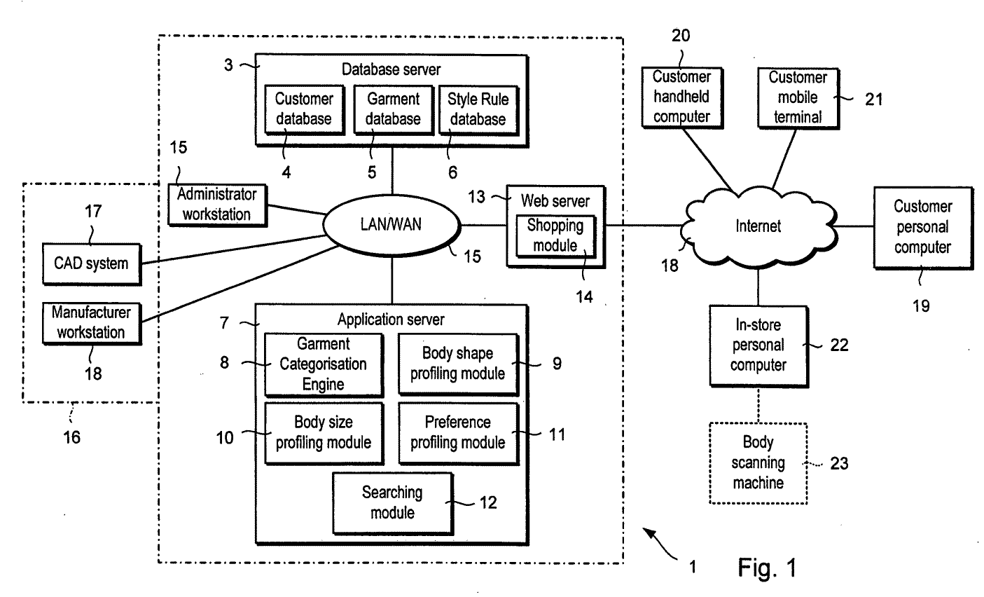

Referring to FIG. 1, a computer-based system 1 is shown for allowing a customer to identify their body shape and to purchase garments from a retailer either on-line or in store.

A retailer's part 2 of the system 1 includes a database server 3 which includes a customer database 4, a garment database 5 and a style rule database 6, an application server 7 which includes a garment categorization module 8, a customer body shape profiling module 9, a customer body size profiling module 10, a customer preference profiling module 11 and a searching module 12, a web server 13 running a shopping server 14 and one or more administrator workstations 15.

Via their workstation 15, an administrator can update style advice rules, a body shape profile template, a body size profile template and a customer preference profile template. The administrator may also manually categorize garments.

The servers 3, 7, 12 and the work station 14 are connected via a local area and/or wide area network(s) 15.

As shown in FIG. 1, a manufacturer's part 16 of the system 1 may include a computer-aided design system 17 and a workstation 18.

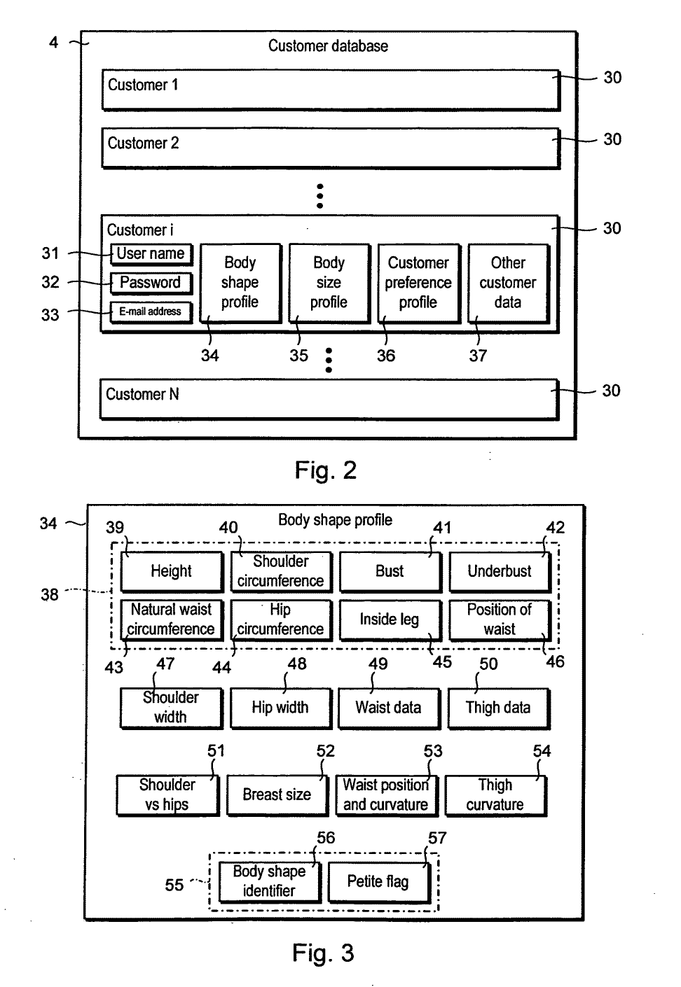

A customer or other subject can obtain their body shape profile 34 (FIG. 2) and other, related profiles 35, 36 (FIG. 2), and shop on-line, via the internet 18 using a personal computer 19 or other device, such as a handheld computer 20 or mobile phone 21. Additionally or alternatively, a customer can also obtain their profile(s) and shop in store. A user, for example a customer or a shop assistant, can access an in-store personal computer or dumb terminal 22.

The body shape profile 34 (FIG. 2) can be obtained by asking the customer questions and the customer providing answers. However, the body shape profile 34 (FIG. 2) can be obtained, at least in part, by using a body scanning machine 23. An example of a body scanning machine is an NX16 available from tc2, 211 Gregson Drive, Cary, N.C. 17511, USA.

As will be explained in more detail later, once the customer has obtained their profiles, for example, in the comfort and convenience of their own home, then they can use the profile(s) when shopping in store. Furthermore, the profile(s) can be used, but not necessarily viewed, by other customers, e.g. friends and family, to purchase a garment as a gift for the customer. In some embodiments, the system need not offer garments for sale and/or be linked to an e-commerce web site. Thus, a user may obtain their profile(s) and use the profile(s) elsewhere, e.g. to purchase garments from any store.

Referring to FIG. 2, the customer database 4 is shown in more detail. The customer database 4 includes, for each customer, a respective entry 30 which includes a user name 31, a password 32, an e-mail address 33, a body shape profile 34, a body size profile 35 and a preference profile 36. An entry 30 can include other information 37, such as items previously viewed, bought or returned.

Referring to FIG. 3, the body shape profile 34 is shown in more detail. The body shape profile 34 includes a set of body measurements 38 including height 39, shoulder circumference 40, bust 41, under bust 42, natural waist 43, hip circumference 44, inside leg 45 and position of waist 46. The body measurements 38 can be supplied by the customer or by a scanning machine 23 (FIG. 1).

The scanning machine 23 (FIG. 1) may also provide a set of ‘projected’ measurements including a shoulder width 47 and hip width 48, i.e. those which do not take into account depth of the customer, e.g. the depth between the front and back of the user at the shoulders and hip. Measurements based on circumference take into account width and depth.

The scanning machine 23 (FIG. 1) may also measure waist shape data 49 and thigh shape data 50.

Based on answers provided by the user or upon scanned measurements, the body shape profile 34 stores a comparison 51 between the widths of the shoulders and hips, breast size 52, the position and curvature of the waist 53 and also thigh shape 54.

A body shape description 55 comprises a body shape identifier 56 and a flag 57 for indicating whether the customer is petite.

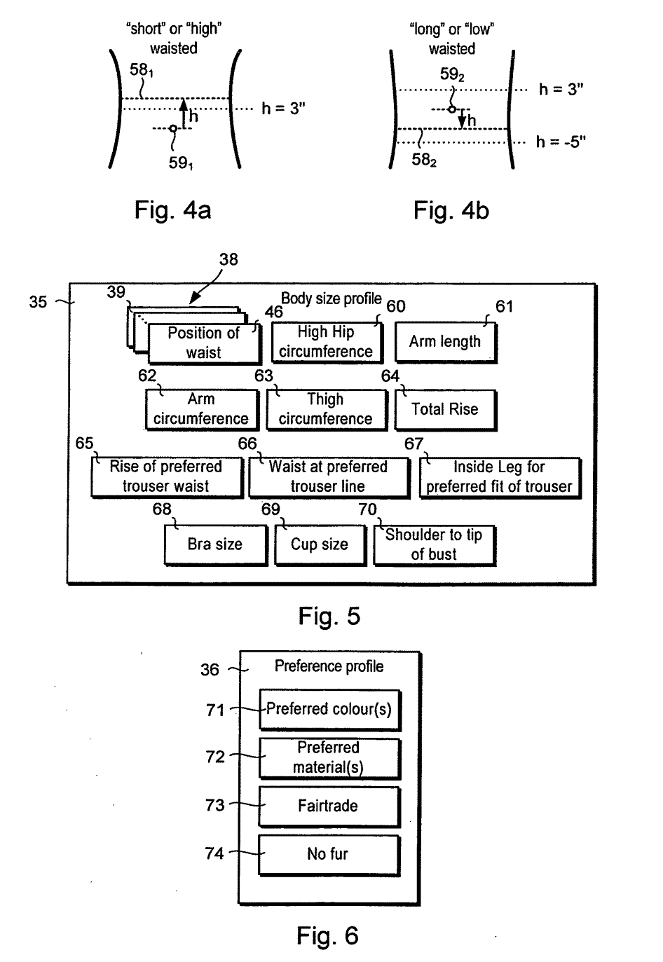

FIGS. 4a and 4b illustrates position of the waist, i.e. a distance, h, of a natural waist 581, 582 above or below the belly button 59₁, 59₂.

If h takes a value which is equal to or greater than about 3 inches (i.e. 3.0, 3.5, 3.0, 4.5, . . . ), then the waist is “short” or “high”. This corresponds to the waistline shown in FIG. 4a.

If h takes a value which is between about 3 inches to about −5 inches (i.e. 2.5, . . . , 0.5, 0, −0.5, −1.0, . . . , −4.5, −5.0 inches), then the waist is “long” or “low”. This corresponds to the waistline shown in FIG. 4b.

Referring to FIG. 5, the body size profile 35 is shown in more detail. The body size profile 35 includes the set of body measurements 38 described earlier, e.g. height 29 and position of waist 46, and additional body measurements including high hip circumference 60, arm length 61, arm circumference 62, thigh circumference 63, total rise 64, rise 65 of preferred trouser waist, waist 66 at preferred trouser line, inside leg 67 for preferred fit of trouser, bra size 68, cup size 69 and shoulder to tip of bust 70. The body size profile 35 may omit some of these body measurements and/or may include other, different body measurements. The set of body measurements 38 can be stored in only the body shape profile 34 and/or the body shape profile 36 or elsewhere.

Referring to FIG. 6, the customer preference profile 36 is shown in more detail. The customer preference profile 36 includes preferences such as preferred colour(s) 71, preferred material(s) 72, whether items presented to the user should be “fair-trade” 73 and whether items can include fur 74. It will be appreciated that preference can vary greatly and the profile shown is merely exemplary.

Referring to FIG. 7, the garment database 5 is shown in more detail. The garment database 5 includes, for each garment, a respective entry 75 which includes a garment make code 76, i.e. a brand name (such as ‘Burberry’) or an internal brand name (such as ‘Per Una’ for Marks and Spencer), a garment type 77 (such as ‘dress’, ‘trouser’, ‘jacket’ etc.), garment descriptor 78 (such as ‘Silk Velvet Bandeau Dress), garment description 79 (such as ‘Strapless knee length dress with centre panel detail’), garment line 80 (such as, for a jacket ‘Fitted’ or ‘straight’, or, for a dress ‘Empire’ ‘wrap’ etc.), garment pattern 81 (such as ‘Plain’ ‘small bud pattern’), neckline 82 (such as ‘bandeau’, ‘boat neck’, ‘polo neck’ etc), sleeve length 83 (such as ‘Sleeveless’, ‘cap sleeved’, ‘¾ sleeve’), one or more garment dimensions of lengths 84 (such as ‘21 inch’), garment fastening 85 (such as ‘side zip fastening’), material composition 86 (such as ‘80% viscose, 20% silk Lining: 100% polyester), trimming 87 (such as 100% polyester), manufacturer's size 88 (such as ‘08’, ‘10’, ‘12’, ‘14’ or ‘16’), care Instructions 89 (such as ‘Dry Clean Only’, ‘Hand Wash’, ‘Machine wash 30 degrees’ etc), garment price 90 (such as £39.95 or $64.99), garment product Code 91 (such as ‘R421884’), body shape code(s) match 92 (such as ‘VF’=Vanilla Fudge, ‘TF’=Tutti Frutti etc) and a garment identifier 93. The entry 75 may include fewer or more data and/or different data. Data can be encoded, e.g. ‘A01’=Dress, ‘C01’=Blue etc).

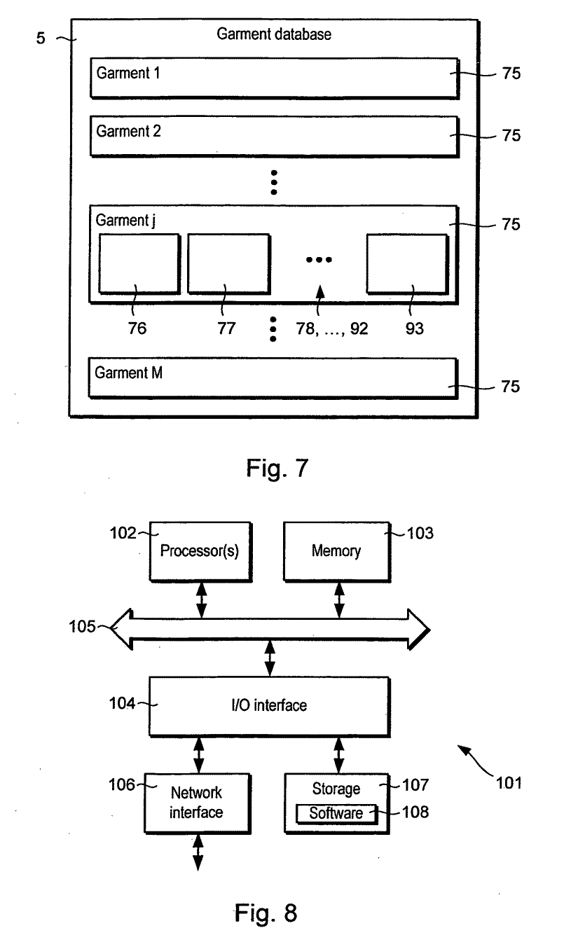

Referring to FIG. 8, a computer system 101 used as, for example, the application server 7, is shown. The computer system 101 includes at least one processor 102, memory 103 and an input/output (I/O) interface 104 operatively connected by a bus 105. The I/O interface 104 is operatively connected to a network interface 106, storage 107 in the form of hard disk storage and removable storage (not shown).

Computer program code 108 is stored in the hard disk storage 107 and loaded into memory 103 for execution by the processor(s) 102 to provide the modules categorization, profiling and buying modules 8, 9, 10, 11. The computer program code 108 may be stored on and transferred from removable storage (not shown) or downloaded via the network interface 106 from a remote source (not shown).

Referring again to FIGS. 1 and 2, the system 1 is intended to streamline shopping.

The customer provides measurements and can answer a few questions, typically between one and four questions, which help to build the body shape profile 34, the body size profile 35 and the preference profiles 36. As will be explained in more detail later, each body shape can be given a name, e.g. Butterscotch, Vanilla Fudge, Walnut Whip, etc. which can help a customer remember their body shape, and a profile identifier which is used by the retailer. Each garment can be categorised and labelled with one or more body shape profiles to indicate the body shape(s) which suit (or do not suit) the garment. The profiles 34, 35, 36 can be used to search for garments and accessories more efficiently since the customer can be presented with items which conform to their profile(s). This can lead to benefits for the customer and the retailer. For example, items purchased based on recommendations which use the body shape profile 34 will generally suit and flatter the customer's body shape and so customer can buy garments with more confidence that they will be satisfied with their purchase and less likely to return items. The retailer can even present items as being the ‘best match’ to a given body size.

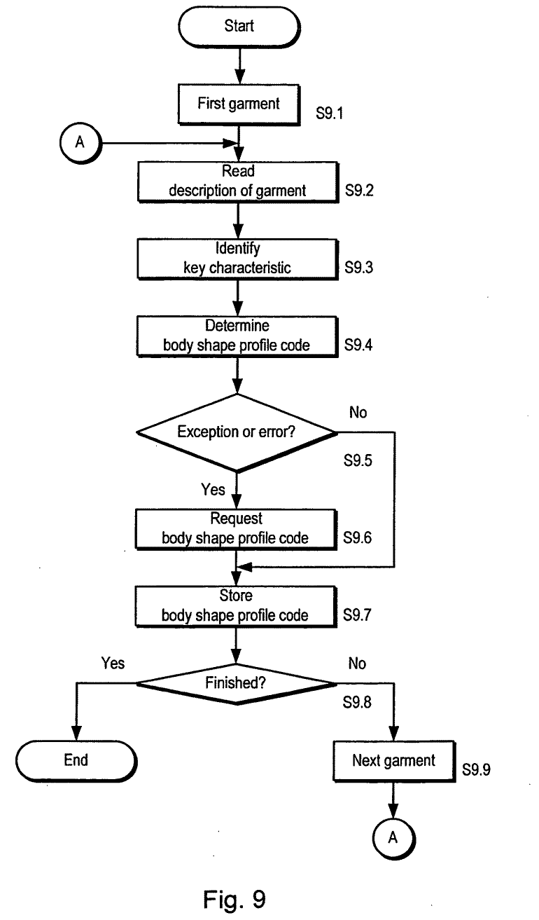

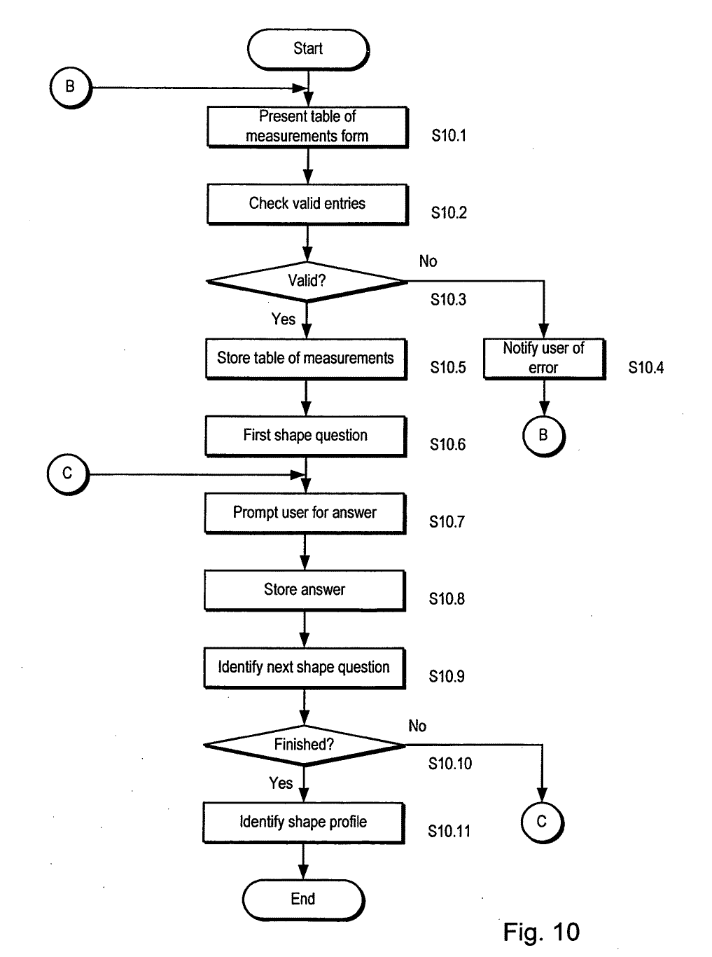

Referring to FIGS. 1, 7 and 9, a method of categorizing garments will now be described.

The garment categorisation module 8 can be run initially on the retailer's garment catalogue and then on a regular basis for new stock.

The module 8 is provided with style advice rules from the style advice database 6 in the form of key characteristics of garments. Starting with a first garment (step S9.1), the module 8 (i.e. the processor 102 (FIG. 8) running under instructions of the software 108) reads a description of a garment (step S9.2) and identifies key characteristics (step S9.3). Tops, for example, may have the following features, such as ‘V-neck’, ‘Round neck’, ‘Roll neck’, ‘polo neck’, ‘crew neck’, ‘cowl neck’, ‘scoop neck’, ‘boat neck’ etc. These different features suit different body shape profiles. The program determines which body shape profile code(s) to assign to the garment (step 9.4). The garment features to be assessed for a given type of garment is predetermined. For example, dresses can be assessed based on a number of key features, such as neckline, line of dress, waist detail, dress length etc.

Even though a garment may have a number of elements which are deemed to suit a particular body shape, it may still be discarded if it has any key features that are identified as being significantly unflattering. For example, if a dress had a fitted waist line but had a deep ‘V’ neck line, then the module 8 may still mark it as being not suitable for a barrel-waisted body shape even though the neckline would be suitable for that body shape. If a garment is identified as having a discordant mix of features, then the garment will be identified as an exception and may require coding manually by a human operator (step S9.5 & S.6).

Body profiles which suit and/or do not suit for garment are stored in the garment database 5 (step S9.7) and the process is repeated for each garment (step S9.8).

The process of categorizing garments can be performed, all or in part, manually. Garments can be categorized using by computer and then new stock can be categorized manually or vice versa.

Having categorised garments, the retailer can help the customer to identify their body shape and body size, and identify their preferences, e.g. colour and fabrics, which can be used to help the customer make better choices when shopping.

Referring again to FIGS. 1 and 2, to identify a body shape profile 34, a body shape profiling module 9 presents the customer with a hierarchy of questions and analyses the customer responses to obtain a body shape profile 34.

The retailer is able to offer style advice by way of written text and graphics for the customer to view, download and print. The retailer can also present garments and accessories for the customer to view and potentially purchase that match the style advice rules of the customer's body shape profile.

Referring still to FIGS. 1 and 2, to identify a body size profile 35, a body size profiling module 10 presents the customer with a body metrics questionnaire and analyses the customer's responses to obtain a body size profile 35 which is stored in customer database 4.

The retailer can choose to compare the customer's body measurements against their store size chart and offer the customer their ‘optimal’ size of garment in their store. For instance, after a customer has completed body measurements, such as waist 30″, hips 39″, inside leg 31″, the store can advise the customer that, when in their store, they should order trousers (“pants”) which are size 14 and regular length. By referring to the stored profile 35, the retailer is able to offer garments that are more likely to fit the customer's specific body dimensions through a comparison process which will be described in more detail later.

Additionally or alternatively, the retailer can choose to compare the customer's body measurements against the measurements of individual garments. The customer completes a variety of body measurements that can then be compared with the dimensions of relevant areas of the garment, allowing for an agreed tolerance. Each of the customer's body measurements can be compared with the relevant areas of the garment.

If a measurement of the relevant body part (allowing for any tolerance) exceeds the measurement of the garment at a given data point, then the garment can be discarded as being unsuitable for the customer to view/purchase. If all measurement comparisons result in positive responses, then the garment can be presented for viewing and potential purchasing by the customer.

Before or after filtering garments according to body measurements, the garments can also be filtered according to body shape and/or preferences. For example, if the user has a given body shape, then only garments which are tagged as being suitable for that given body shape are searched or, if already found in a search, presented. Likewise, if the customer has indicated that they do not wear wool, then woollen items will not be included in the search or presented. Similarly, if the customer expresses a preference for black trousers (i.e. “pants”), then brown trousers will not be included in the search or presented.

A customer preference module 11 can allow the retailer to offer various options to the customer. For example, the customer can indicate their preference for colour choices, types of materials and ethical choices, such as buying “fair trade” cotton, no fur etc. The retailer can use this, along with other profiles, as the basis for search criteria for the customer and only offer the customer items that they would find desirable to purchase. By storing a preference profile 36, the customer need not constantly select criteria every time they conduct a search.

In addition to garments, the retailer may also present suitable accessories, such as bags, hats, jewellery, according to one or more or all of the profiles. For example, handbags of a certain size and/or shape may suit a body of given shape and/or size.

A gift advisory module can take advantage of the profiles 34, 35, 36 to help another customer buy a garment or garments for the customer. For example, the other customer can identify the customer for whom they wish to buy a gift using, for example, an e-mail address and/or name. Although the customer's profiles are not available to the purchaser to view, the merchandise presented to them conforms to the criteria of the profiles. This can help ensure that, while the gift will be a surprise, it is more likely to appeal to the recipient as it would comply with their pre-selected and stored preferences.

An example of a process of identifying a body shape profile 34, a body size profile 35 and a customer preference profile 36 will now be described in more detail.

In this example, a retailer provides a body shape profiling as part of their on-line shop. However, other arrangements can be used. For example, the retailer may provide a body shape profiling service on a standalone system in store. The user may download a body shape profiling program onto their home computer or mobile device. A third party may provide an on-line body shape profiling service and retailers categorise their stock according to the body shape profiles.

The customer accesses the shopping server 14 and sets up an account, for example, using a name, password and e-mail address. The customer may also specify payment and delivery details for allowing the customer to purchase garments and for the garments to be delivered without the need for entering these details each time they wish to make a purchase.

A new customer may be presented with an introduction as to how profiling works and list its benefits. The customer can start the profiling process by clinking on a link, for example marked “What's my body shape?”

The shopping server 14 exchanges data with the body shape profiling module 9, e.g. using JavaSenrer Pages, to determine the customer's body shape.

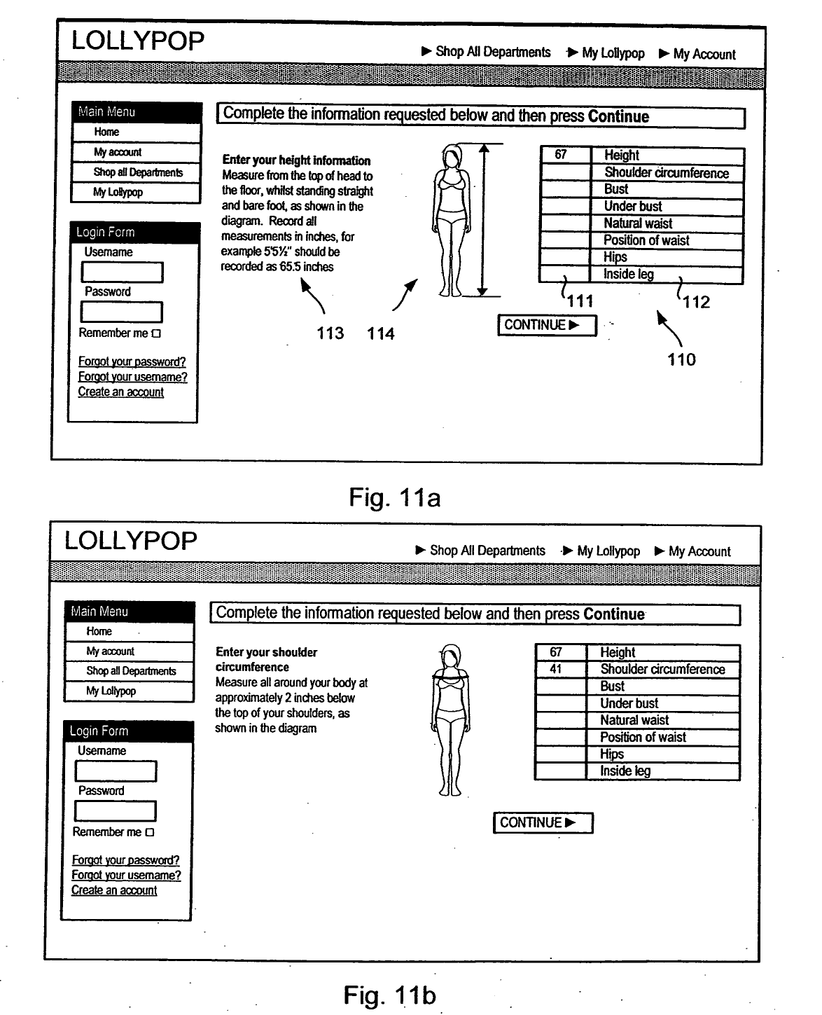

Referring to FIGS. 1, 2, 3, 11a and 11b, the body shape profiling module 9 prompts the customer to fill out a form 110 of measurements, which include fields 111 for entering measurements and corresponding descriptions of the measurement 112. The module 9 checks that the form 110 contains valid entries and, if so, stores the form in the body shape profile 34 (steps S10.1 to S10.5).

The form 110 includes a first set of body measurements for the customer, namely height, circumference of shoulders, bust, under bust, natural waist, position of waist, hip and inside leg measurement. A greater or smaller number of measurements may be taken and/or alternative measurements may be used.

The customer can be prompted to fill out each field one-at-a-time and presented with guidance, e.g. text 113 and a graphical image or representation 114, on taking a measurement.

The measurements requested in the form 110 have two intended purposes.

Firstly, the measurements can be compared with an online retailer's size chart to assess the user's size, for example, if a person is a size 10 skirt, size 12 blouse, petite trouser length, bra size etc.

Secondly, some of the measurements, in particular the shoulder circumference, position of waist and height, can be subsequently used in a subsequent categorization process, e.g. to determine whether the user is “broad” or “narrow”, high waisted etc.

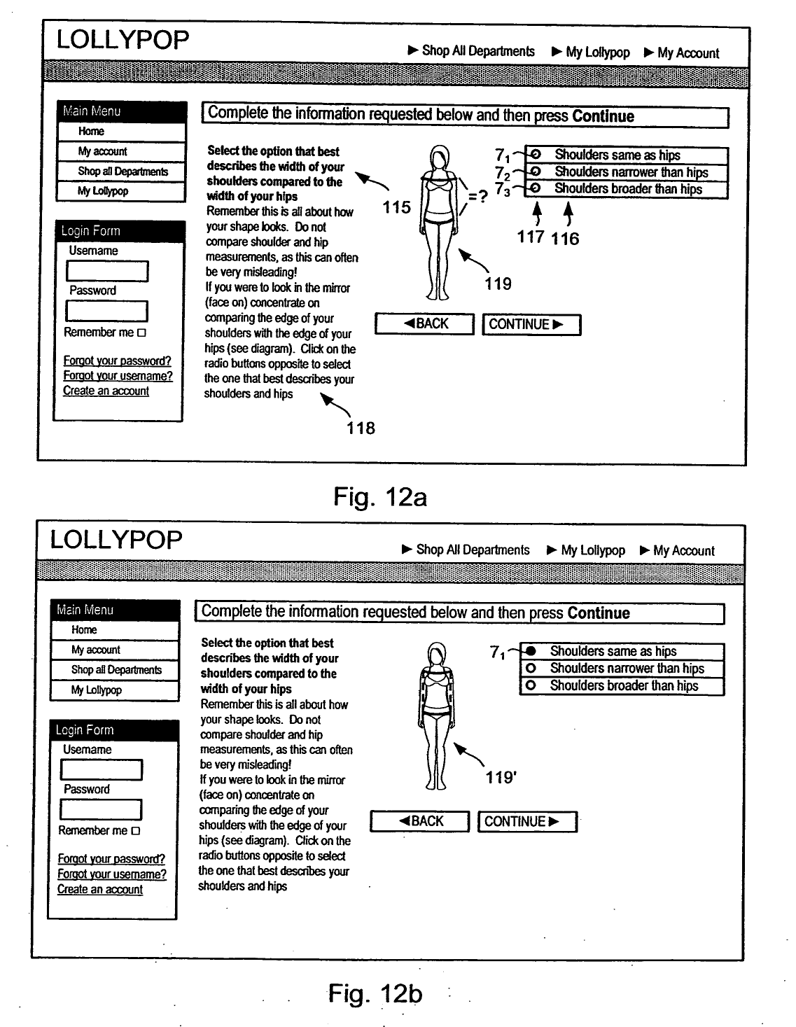

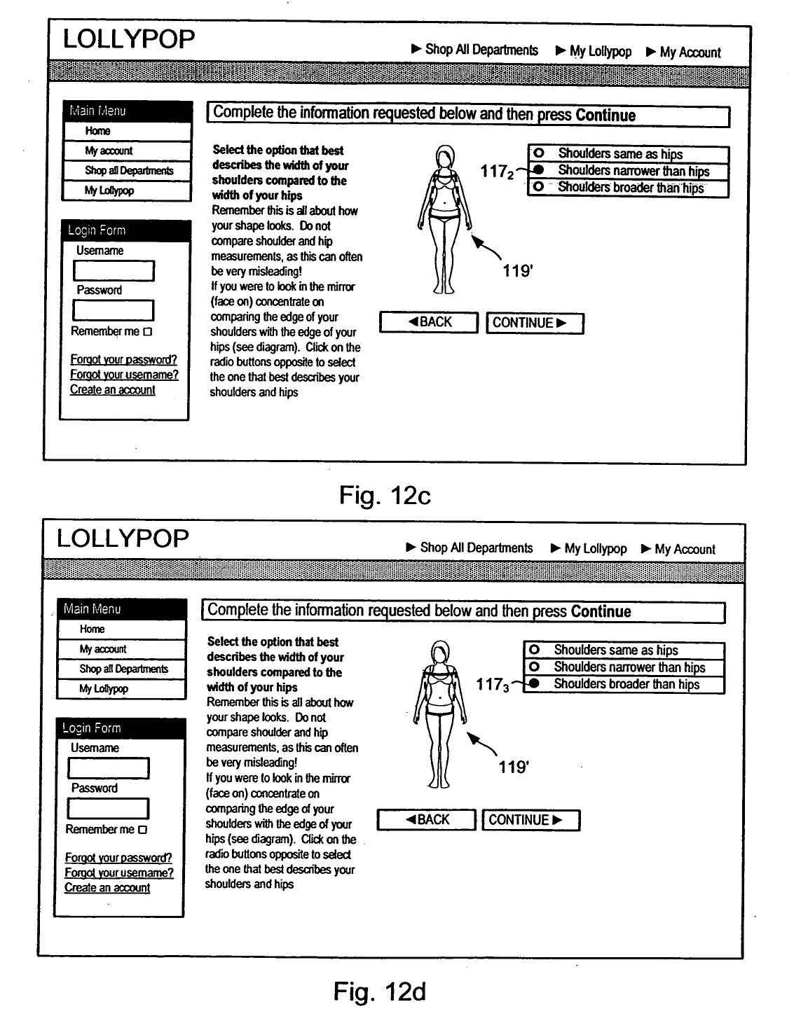

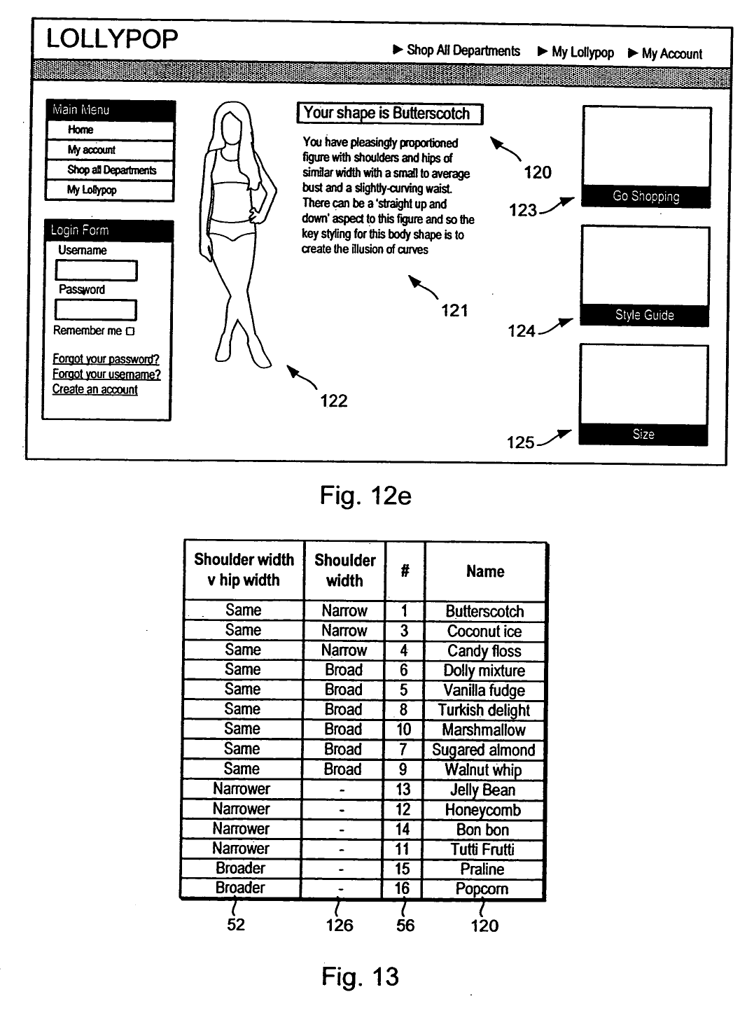

Referring also to FIG. 12a, having completed a first part of the body profile categorization process, the customer is presented with a first of series of questions 115 in a second part of categorization process (step S10.6).

Each question 115 is usually presented in the form of query, for example “Select the option that best describes how your shoulder size compares to your hips”, and two or more possible answers 116, such as “Shoulders same width as hips”, “Shoulders narrower than hips” and “Shoulders broader than hips” each having a corresponding user-selectable radio button 117 or check box.

The customer may be helped to answer the question using text 118 and a graphical representation 119.

Referring also to FIGS. 12b to 12d, the customer is helped further through feedback. When the customer selects an answer, a modified graphic 119′ illustrating a corresponding body part shape is presented.

The module 9 prompts the customer for an answer (step S10.7), stores the answer (step S10.8) and, based on the answer and/or measurements supplied in the table 110, selects the next appropriate question (step S10.9) until it has finished (step S10.10) and has identified a body shape 56 (step S10.11) which is stored in the body shape profile 34. Thus, the module 9 seeks to deduce which body profiles do not reflect the customer's true body shape and eliminates these body shapes until one body shape remains. The profile 34 can be retrieved, viewed and edited by the customer.

By asking the customer questions about, for example, relative appearance of different parts of the body, such as the width of the shoulders and width of hip, valuable information about the customer's body shape can be quickly obtained which can help the module 9 to estimate, with sufficient accuracy, the shape of the customer's body.

The number of questions required to find the customer's body shape depends on which answers are provided. For example, the module 9 may only need one further piece of information (e.g. which may be provided in the form of an answer to a question presented to the customer or a measurement) to determine the body shape of the customer.

Referring to FIG. 12e, at the end of the process, the module 9 presents the customer with a body shape name 120, textual description 121 and a graphical representation 122. The customer then has the opportunity select links 123, 124, 125 to go shopping, to obtain style advice or to provide further body size measurements.

As mentioned earlier, the first question 115 (FIG. 12a) presented to the customer is whether the customer's shoulders appear to be the same width, wider or narrower than the hips.

Referring to FIG. 13, an answer 52 to this question 115 can be used to categorise body shapes into several (e.g. 15) groups. Other information can also be used, such as an answer to a question as to whether the shoulders are broad or narrow. Body shapes can be assigned an identifier 56 and a name 120. Together with answers to up three other questions and up to a further two other measurements, the question “Are your shoulders broader, the same width or narrower than your hips” can be used to provide a surprising sophisticated model of the customer's body shape.

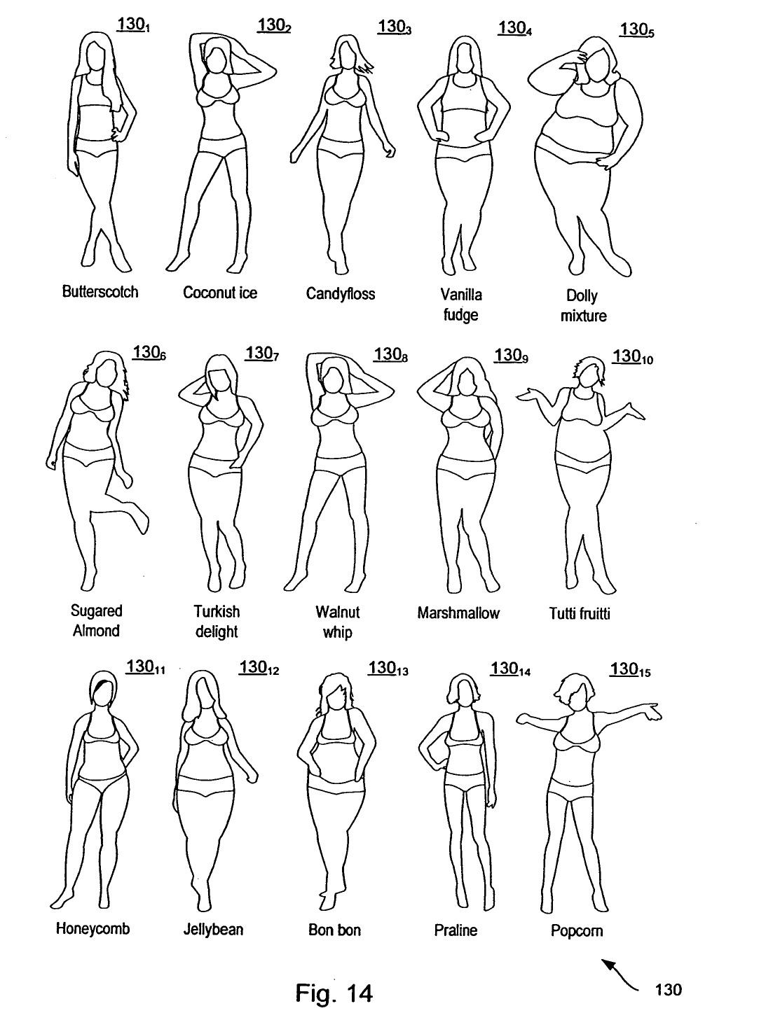

Referring to FIG. 14, representations 130₁, 130₂, . . . , 130₁₅ of the body shapes are shown.

In this example, fifteen body shape categories are defined. However, more or fewer categories may be defined. For example, two (or more) similar categories may be combined into a single category.

The body shape profile 34 (FIG. 2) can be obtained by asking the customer questions. However, the body shape profile 34 (FIG. 2) can be obtained using a scanner 23 (FIG. 1).

The second part of categorization process will now be described in more detail.

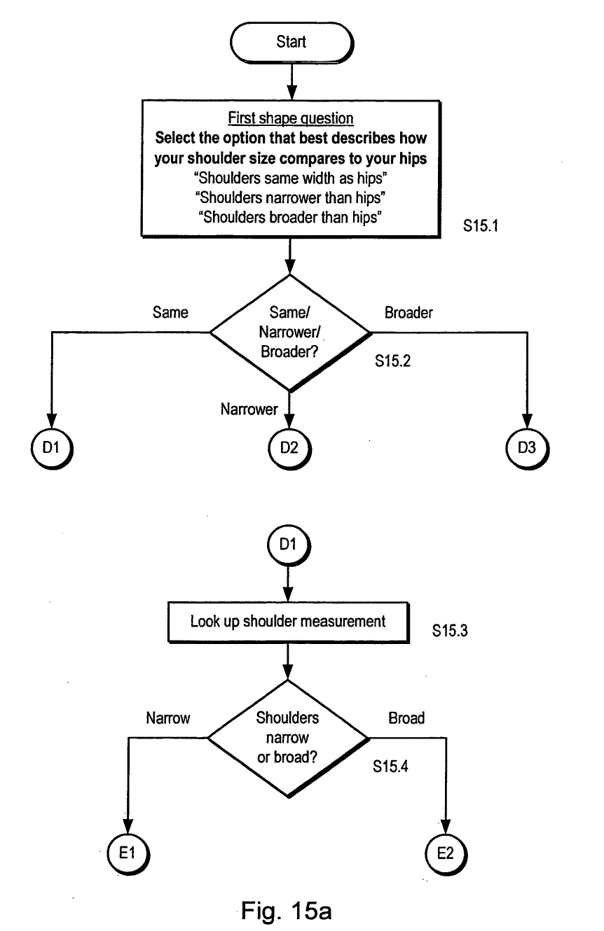

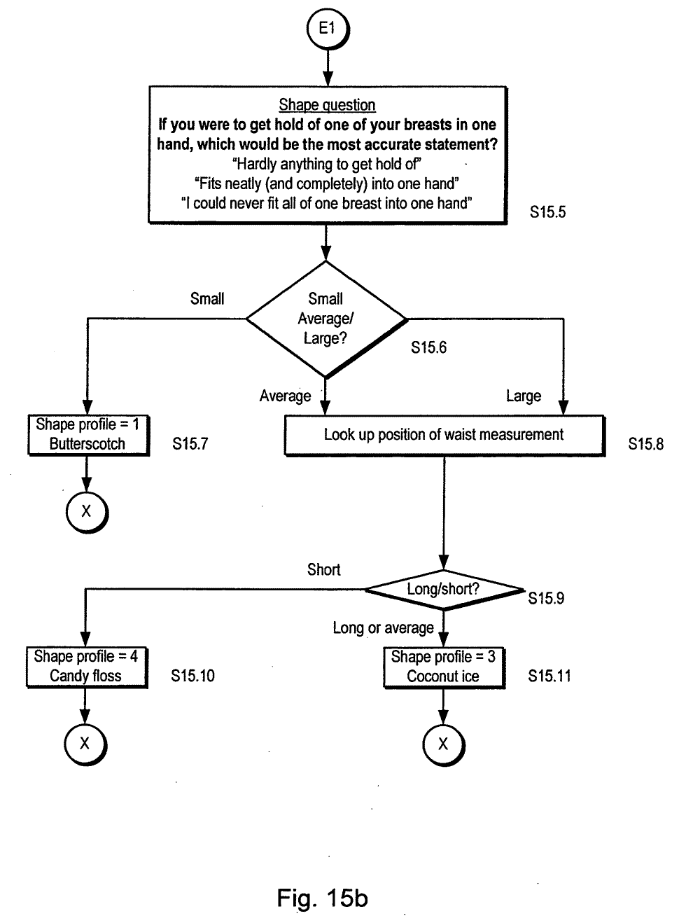

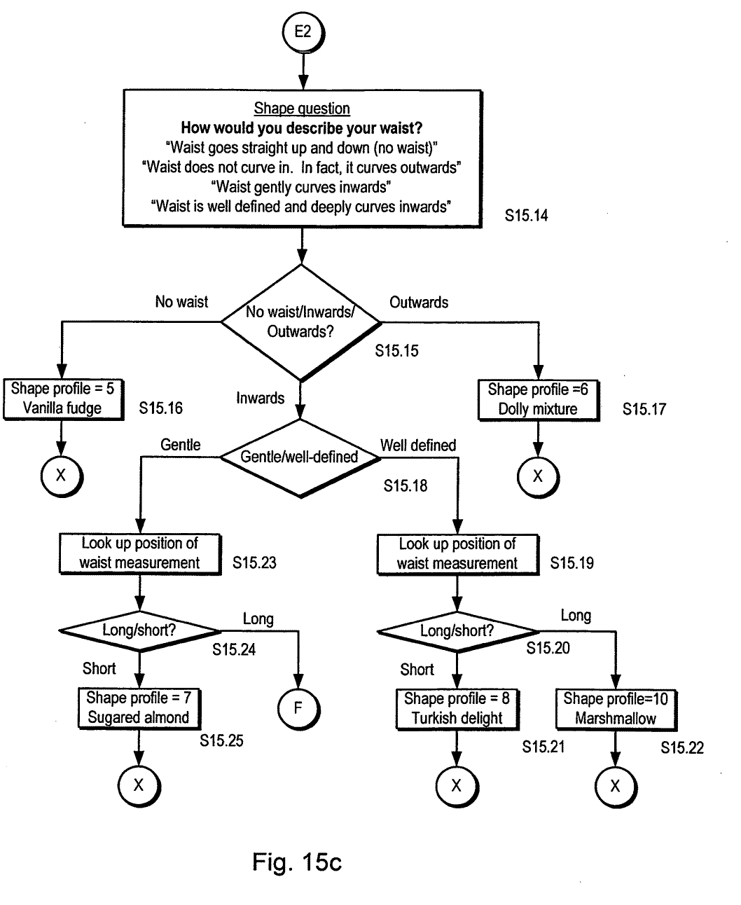

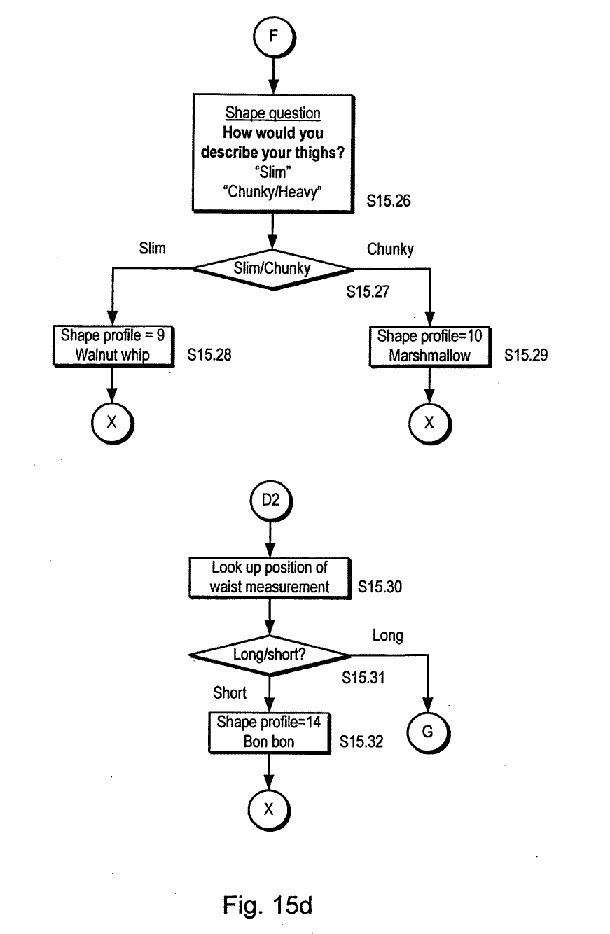

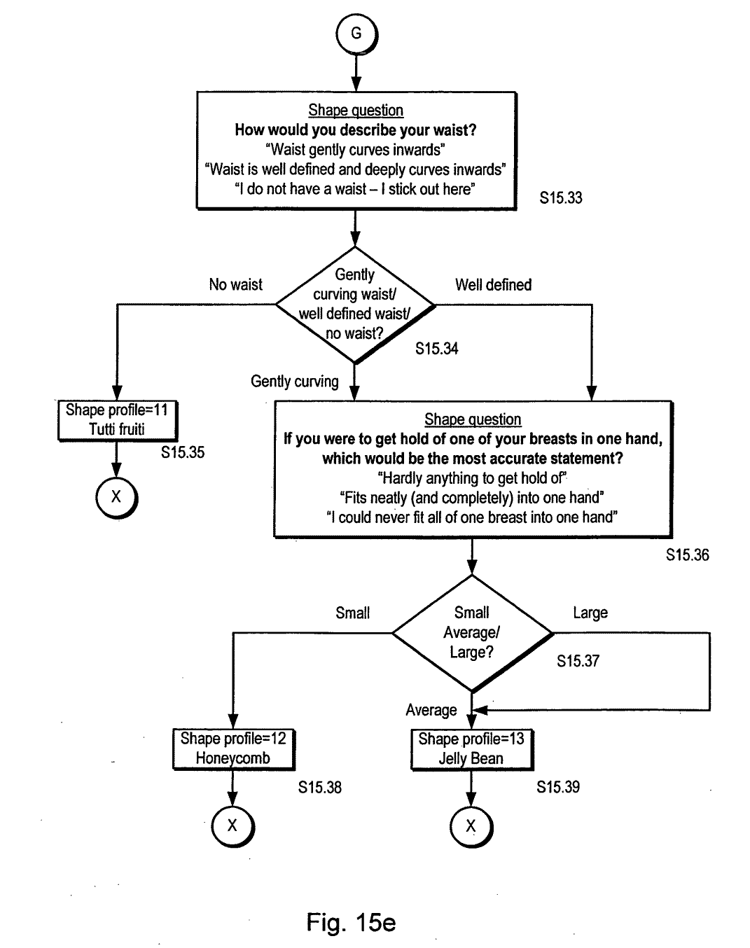

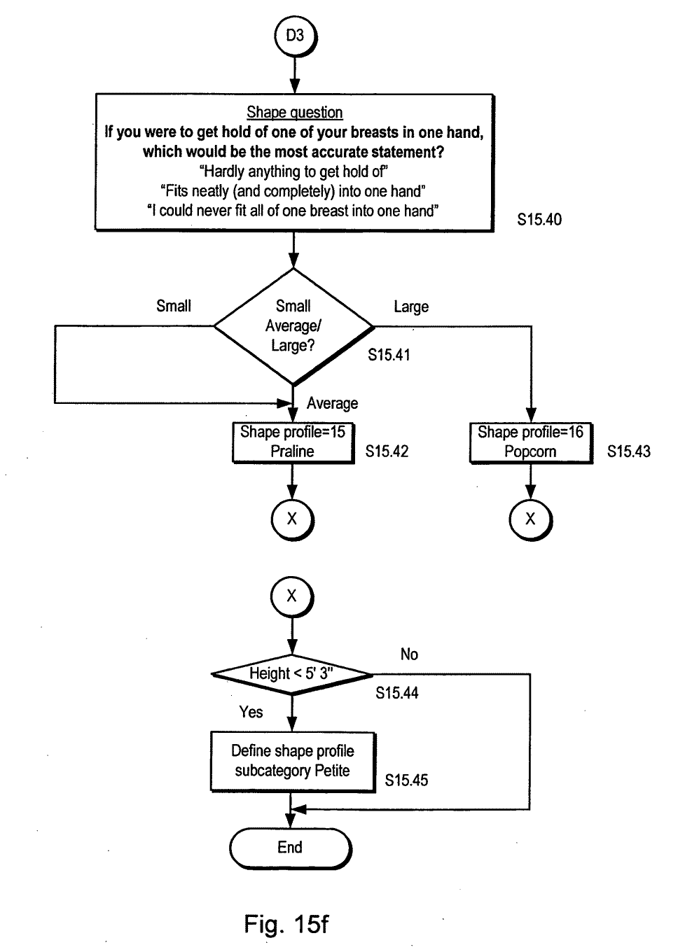

Referring to FIG. 15a and also to FIG. 12a, the module 9 prompts the customer to answer the question “Select the option that best describes how your shoulder size compares to your hips” 115 with three choices, namely: “Shoulders same width as hips”, “Shoulders narrower than hips” and “Shoulders broader than hips” (step S15.1).

The customer selects one of the choices 117₁, 117₂, 117₃ as their answer, which the module 9 can store.

This question is insightful because a two-dimensional shape measurement (i.e. with two components, e.g. width and depth), such as shoulders, may not translate accurately into a one-dimensional measurement (i.e. with a single, projected component, e.g. width only) that can be compared with another similar two-dimensional measurement shape measurement, such as hips.

The module 9 determines which answer the customer has chosen (step S15.2).

If the customer chooses the answer “the same”, then the module 9 looks up the shoulder circumference measurement (step S15.3) and compares the value to a predetermined value to identify whether the shoulders are “broad” or “narrow” (step S15.4).

The predetermined value is 42 inches. Thus, if the measurement is less than 42 inches, then the shoulders are deemed to be “narrow”. Otherwise, i.e. if the measurement is equal to or greater than 42 inches, then the shoulders are deemed to be “broad”. The predetermined value may be set to a different value, for example, in the range 40 to 44 inches, based on, for instance, cultural and/or demographical factors of the market the retailer is supplying.

Referring to FIG. 15b, if the shoulders are deemed to be narrow, then the module 9 prompts the customer to answer the question “If you were to get hold of one of your breasts in one hand, which would be the most accurate statement” with three choices, namely “Hardly anything to get hold of”, “Fits neatly (and completely) into one hand” and “I could never fit all of one breast into one hand” (step S15.5). The question and the choices may be phrased differently. The number of choices can differ.

The customer selects one of the choices as their answer, which the module 9 can store.

This question is useful since it can be difficult to determine whether a bust is small, medium or large from just a bra size because female customers may be wearing the wrong size of bra.

The question (and questions along similar lines) is framed in such a way as to help the customer to answer quickly and truthfully and so determine whether their bust is small, medium (e.g. average) or large.

The module 9 determines which answer the customer has chosen (step S15.6).

Notwithstanding that women may be wearing the incorrect size of bra, in some embodiments, the answer may be based on (or checked against) bra cup size. Cup sizes ‘AA’, ‘A’ and ‘B’ can be labelled as being small, cup sizes ‘C’ and ‘D’ may be deemed to be medium and those ‘DD’, ‘E’ and above are considered to be large.

If the customer gives an answer which indicates a small bust size, then the module 9 identifies that the customer has the body shape “Butterscotch” (FIG. 14) (step S15.7).

Referring also to FIG. 12e, the module 9 presents an image 122 of the body shape profile on the screen of, e.g. the customer's computer, and saves the profile identifier in the database 4 (FIG. 1). In the following, whenever the module 9 identifies a body shape profile, it presents the appropriate image of the body shape profile (FIG. 14) and saves the profile identifier in the database 4 (FIG. 1).

If the customer gives an answer which indicates an average or large bust size, then the module 9 looks up the “position of waist” measurement (step S15.8) and determines whether the customer has a “long” or “average” waist or a “short” waist (step S15.9).

In this example, a “long” or “average” waist takes a value between less than 3 inches to about −5 inches (i.e. 2.5, . . . , 0.5, 0, −0.5, −1.0, . . . , −4.5, −5.0 inches) and a “short” waist takes a value which is equal to or greater than about 3 inches (i.e. 3.0, 3.5, 3.0, 4.5, . . . ). A different range, e.g. narrower or wider and/or shifted up or down, can be used, based on, for instance, cultural and/or demographical factors of the market the retailer is supplying.

If the customer has a “short” waist, then the module 9 identifies that the customer has the body shape “Candy Floss” (FIG. 14) (step S15.10). The module 9 presents an image of the body shape profile and saves the profile identifier in the database 4 (FIG. 1).

If the customer has a “long” or “average” waist, then the module 9 identifies that the customer has the body shape “Coconut ice” (FIG. 14) (step S15.11).

Referring to FIG. 15c, if the module 9 determines in step S15.4 (FIG. 15a) that shoulders are broad, then the module 9 prompts the customer to answer the question “How would you describe your waist?” with four choices, namely “Waist goes straight up and down (no waist)”, “Waist does not curve in. In fact, it curves outwards”, “Waist gently curves inwards” and “Waist is well defined and deeply curves inwards” (step S15.14). Again, the question and the choices may be phrased differently and the number of choices can differ.

The customer selects one of the choices as their answer, which the module 9 can store.

If the customer gives an answer which indicates that they have no waist, then the module 9 identifies that the customer has the body shape profile “Vanilla Fudge” (FIG. 14) (step S15.16).

If the customer provides an answer indicating that they have an outwardly curving waist, then the module 9 identifies that the customer has the body shape profile “Dolly mixture” (FIG. 14) (step S15.17).

If the customer has a well-defined, inwardly curving waist, then the module 9 looks up the “position of waist” measurement (step S15.19) and determines whether the customer has a “long” or “average” waist or a “short” waist (step S15.20).

If the customer has a “short” waist, then the module 9 identifies that the customer has the body shape profile “Turkish Delight” (FIG. 14) (step S15.21). If the customer has a “long” or “average” waist, then the module 9 identifies that the customer has the body shape profile “Marshmallow” (FIG. 14) (step S15.22).

If the customer has a gently, inwardly curving waist, then the module 9 also looks up the “position of waist” measurement (step S15.23) and determines whether the customer has a “long” or “average” waist or a “short” waist (step S15.24).

If the customer has a “short” waist, then the module 9 identifies that the customer has the body shape profile “Sugared almond” (FIG. 14) (step S15.25).

Referring to FIG. 15d, if the customer has a “long” or “average” waist, then the module 9 prompts the customer to answer the question “How would you describe your thighs?” with two choices, namely “Slim” and “Chunky or heavy” (step S15.26).

The module 9 determines which answer the customer has chosen (step S15.27).

If the customer gives an answer which indicates that they have slim thighs, then the module 9 identifies that the customer has the body shape profile “Walnut whip” (FIG. 14) (step S15.28). Otherwise, the module 9 identifies that the customer has the body shape profile “Marshmallow” (FIG. 14) (step S15.29).

Referring still to FIG. 15d, if the module 9 determines in step S15.2 (FIG. 15a) that shoulders are narrower than the hips, then the module 9 looks up the “position of waist” measurement (step S15.30) and determines whether the customer has a “long” or “average” waist or a “short” waist (step S15.31).

If the customer has a “short” waist, then the module 9 identifies that the customer has the body shape profile “Bon bon” (FIG. 14) (step S15.32).

Referring to FIG. 15e, if the customer has a “long” or “average” waist, then the module prompts the customer to answer the question “How would you describe your waist?” with three choices, namely “Waist goes straight up and down (no waist)”, “Waist does not curve in. In fact, it curves outwards”, “Waist gently curves inwards” and “Waist is well defined and deeply curves inwards” (step S15.33).

The customer selects one of the choices as their answer, which the module 9 can store.

If the customer gives an answer which indicates that they have no waist or an outwardly curving waist, then the module 9 identifies in step S15.34 that the customer has the body shape profile “Tutti frutti” (FIG. 14) (step S15.35).

If the customer provides an answer indicating that they have an inwardly curving waist, then the module 9 prompts the customer to answer the question “If you were to get hold of one of your breasts in one hand, which would be the most accurate statement” with three choices, namely “Hardly anything to get hold of”, “Fits neatly (and completely) into one hand” and “I could never fit all of one breast into one hand” (step S15.36).

The customer selects one of the choices as their answer, which the module 9 can store.

The module 9 determines which answer the customer has chosen (step S15.37).

If the customer gives an answer which indicates a small bust size, then the module 9 identifies that the customer has the body shape profile “Honeycomb” (FIG. 14) (step S15.38). If the customer gives an answer which indicates an average or large bust size, then the module 9 identifies that the customer has the body shape “Jelly Bean” (FIG. 14) (step S15.39).

Referring to FIG. 15f, if the module 9 determines in step S15.2 (FIG. 15a) that shoulders are broader than the hips, then the module 9 prompts the customer to answer the question “If you were to get hold of one of your breasts in one hand, which would be the most accurate statement” with three choices, namely “Hardly anything to get hold of”, “Fits neatly (and completely) into one hand” and “I could never fit all of one breast into one hand” (step S15.40).

The customer selects one of the choices as their answer, which the module 9 can store.

The module 9 determines which answer the customer has chosen (step S15.40).

If the customer gives an answer which indicates a small or average bust size, then the module 9 identifies that the customer has the body shape profile “Praline” (FIG. 14) (step S15.42). If the customer gives an answer which indicates a large bust size, then the module 9 identifies that the customer has the body shape “Popcorn” (FIG. 14) (step S15.43).

Referring to FIG. 15f, once a body shape has been identified, a further check is made whether the customer is under 5 foot 3 inches tall (step S15.44). If so, the body shape is labelled as being “petite” and a corresponding flag 57 (FIG. 2) is set. Thus, if the customer is identified as being “Butterscotch” and is under 5 foot 3 inches tall, then their modified body profile is “Petite Butterscotch”.

According to this categorization process, a customer can quickly identify their body shape by providing a few measurements and answering a few questions.

Some of the data, such as measurements for natural waist, hips and inside leg measurements are not necessarily used to identify body shape.

The body shape profile can be used to identify the type of garments which will suit the body shape of the customer. However, the garment still needs to fit the customer and so further information about the size of the customer is required.

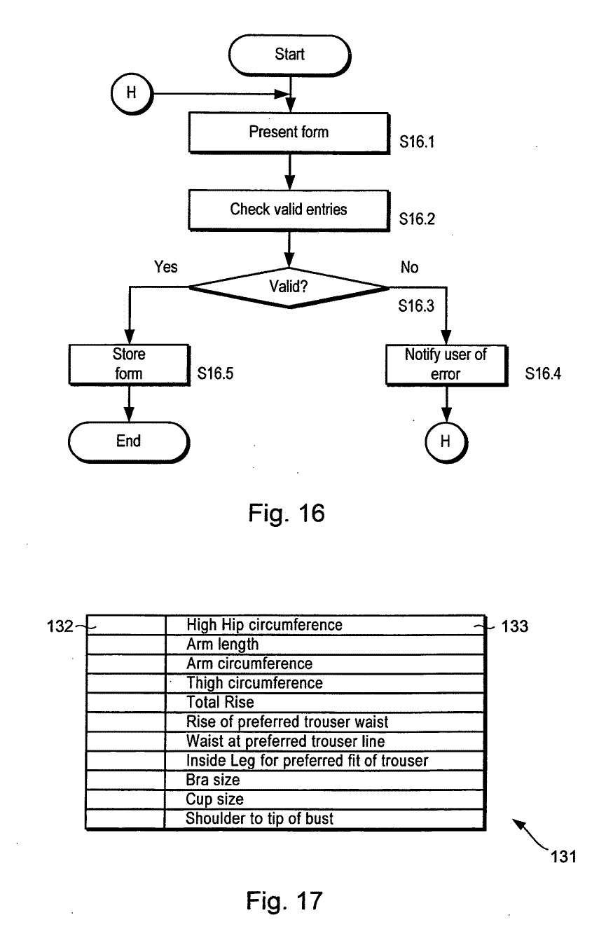

Referring to FIGS. 1, 2, 5, 16 and 17, the body size profiling module 10 prompts the customer to fill out a form 131 of measurements, which include fields 132 for entering measurements and corresponding descriptions of the measurement 133, checks the form contains valid entries and, if so, stores the entries in the body size profile 35 (steps S16.1 to S16.5).

The form 131 includes a first set of body measurements, namely high hip circumference arm length, arm circumference, thigh circumference, total rise, rise of preferred trouser waist, waist at preferred trouser line, inside leg for preferred fit of trouser, bra size, cup size and shoulder to tip of bust. The form 131 may include other different measurements and/or some measurements listed may be omitted.

The customer can be prompted to fill out each field one-at-a-time and presented with guidance on taking a measurement.

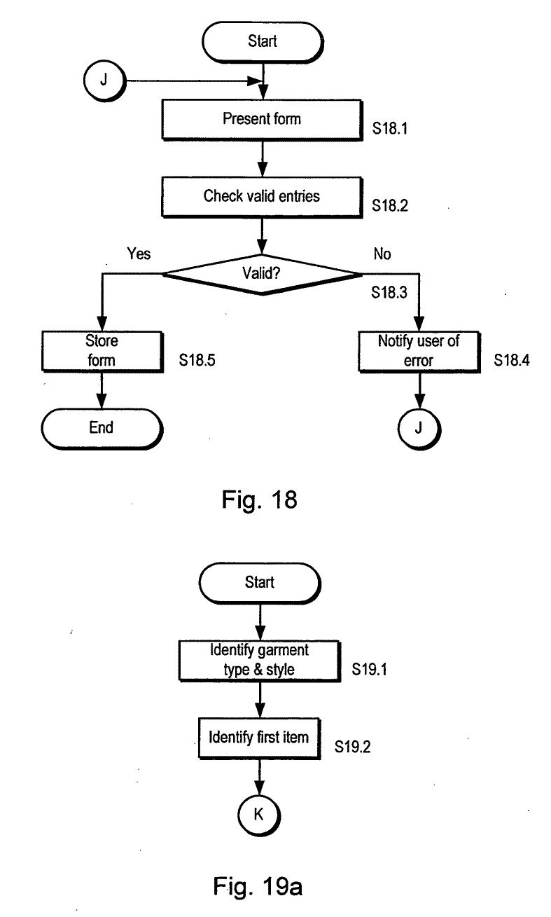

Referring to FIGS. 1, 2, and 18, the body size profiling module 11 presents a form to the customer which can include pull down menus, radio buttons and data entry fields to allow the customer to enter their preferences about, for example, preferred types of clothing materials (i.e. those that should be included), types of clothing materials to avoid, lifestyle or moral choices, such as “fair-trade” products only or no fur, preferred colours etc. (steps S18.1 to S18.5).

Once a body shape profile, body size profile and/or a preference size profile has or have been selected, the customer can search the garment catalogue for items to purchase.

The customer accesses the web server 13 and logs into their account, they can choose the type of garment they are seeking, e.g. trousers, and the type of style or occasion for which the garment will be used, e.g. casual, formal etc.

Referring to FIGS. 1, 2 and 19a, a search engine 12 sends a query the garment database 5 for garments of type and style which identifies a list of garments (step S19.1).

The search engine 14 can then identifies a first garment (step S19.2).

Each item is tagged with the type of body shapes which it flatters and/or the types of body shapes it does not flatter. Each item is also tagged with an appropriate set of measurements. For example, for a pair of trousers, this may include rise, inside leg measurement etc. Each item is also tagged with labels and descriptors, e.g. describing the type(s) of material from which it is made, its colour, whether the item is a “fair-trade” product and so on.

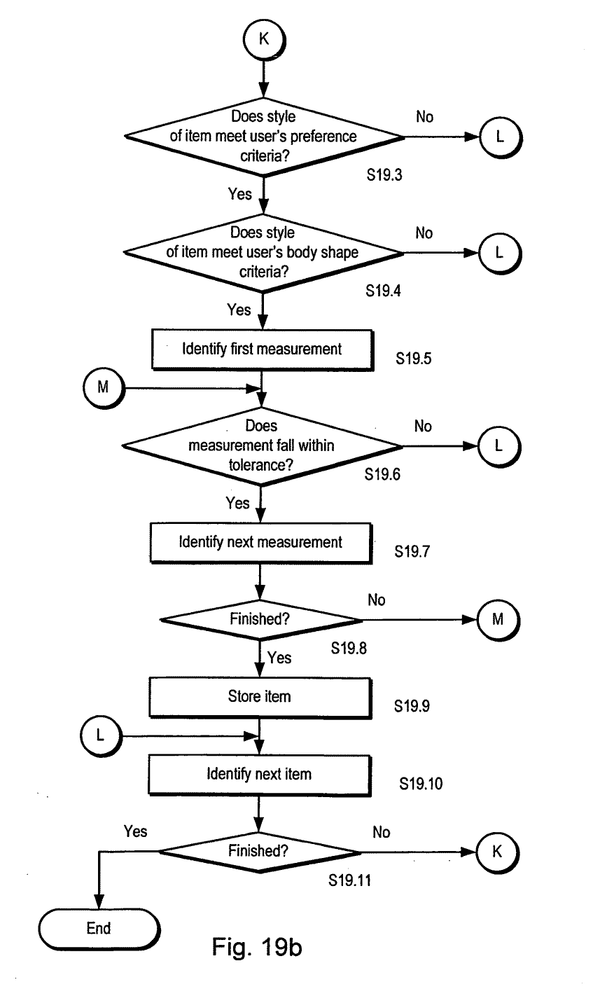

Referring to FIG. 19b, the search engine 12 checks whether e.g. colour and material composition of the item matches the customer's preference profile (step S19.3). If the item does match the relevant preference in the profile, the search engine 12 checks whether the style of the item matches the customer's body shape profile (step S19.4). If item is identified as being suitable for the customer's body shape, then the search engine 14 checks whether each of the user's measurements falls within a range of values for the corresponding dimensions of the garment (step S19.5 to step S19.9).

If any garment does not match the relevant preference in the profile, or if it is not appropriate for the customer's body shape or if a measurement does not fall within the appropriate range, then the item is not stored or kept in a list.

The process is repeated for each item (step S19.10 & S19.11).

Thus, at the end of the searching process, the customer can be presented with a list of items, e.g. using photographs, corresponding text description and price. Larger or additional photographs and further details may be presented by selecting the item. Also, an option to add the item to a shopping basket is provided to facilitate easy selection and purchase of items.

The customer may benefit from the use of the profiles in other ways. For example, a friend or relative can purchase garments for the customer using the one or more of the profiles. Although the gift purchaser may not be able to view the details that make up the profiles, they may identify the customer, e.g. using their e-mail address or a customer identifier, and select the types of items they wish to buy. The search module 12 can look for items in the same way as that described earlier.

The purchaser accesses the web server 13 and logs into their account.

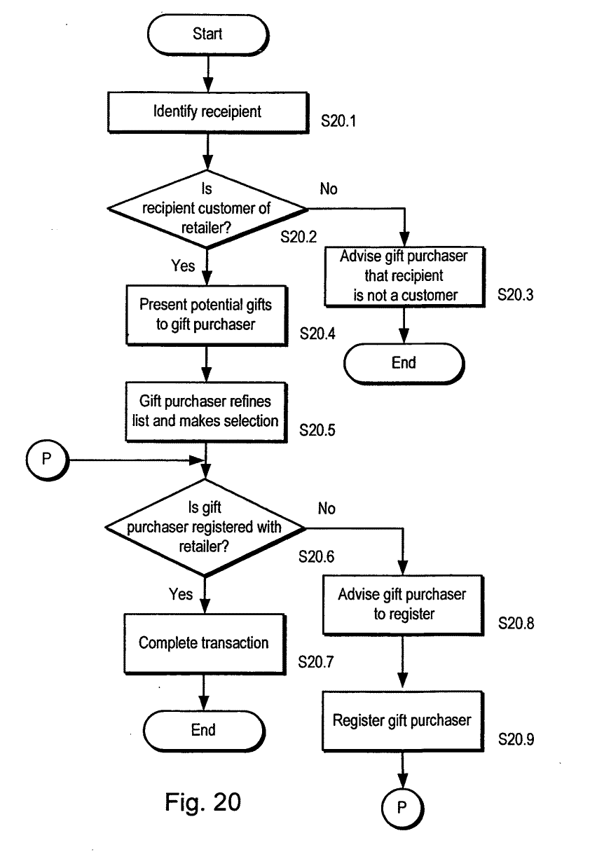

Referring to FIGS. 1, 2 and 20, the purchaser identifies the recipient (step S20.1). The shopping server 14 checks whether the recipient is a customer of the retailer (step S20.2). If not, the shopping server 14 notifies the purchaser (set S20.3). If so, the server 14 retrieves a list of potential gifts based upon the recipient's profile(s) and presents them, for example, in the form of a gallery of thumbnail images (step S20.4). The image may show a model modelling one or more items. The purchaser can filter the list, make a selection and proceed to checkout (step S20.5).

The shopping server 14 checks whether the purchaser registered with the retailer (step S20.6). If so, the transaction can be completed (step S20.7). Otherwise, the shopping server 14 advises the purchaser that they are not registered (step S20.8) and proceeds by registering the user, e.g. requesting payment details (step S20.9)

The purchaser may be able to purchase items for more than one customer and so may be able to select one of several customers. Moreover, one customer who has their own profiles may be able to purchase items for one or more other customers, each having respective profiles.

It will be appreciated that many modifications may be made to the embodiments hereinbefore described.

For example, although examples of body shapes are described in relation to purchasing women's garments, body shape profiles can be used to aid purchasing of garments for men, boys and girls.

The profiles can be viewed, edited and saved. For example, the user may be able to change measurement(s) and/or answer(s) to questions.

The body shape profiling module, the body size profiling module and/or customer preference module, and corresponding databases can be located elsewhere and used in a different way to that that described earlier.

For example, the module(s) and corresponding database(s) can be provided by a third party (i.e. which is different to the customer and retailer). Thus, a potential customer can access a website of the third party and obtain their body shape profile and other profiles. The third party may direct the potential customer to suitable retailer(s). The retailer may use the profile(s) provided by the customer or the third party. The retailer or another party may categorise the retailer's stock. The retailer may offer the customer a menu option to filter garments according to body shape or only present garments to the customer which suits their body shape.

The module(s) and corresponding database(s) can be located on a stand-alone computer system. For example, the customer may download an application, e.g. applet, onto their computer, mobile phone of other device. Additionally or alternatively, a retailer may have a kiosk which is accessed by the customer or a sales assistant.

A body shape may be split into two or more body shapes, e.g. upper and lower parts of the body. Thus, the system may be configured to identify an upper body profile and/or a lower body profile. Two or more ‘whole’ body shapes can share the same upper body shape but have different lower body shapes. Thus, a ‘whole’ body profile may be formed as a composite of upper and lower body profiles. Having separate upper and lower body shapes can simplify profiling, tagging of garments and/or providing advice. Thus, two ‘whole’ body profiles sharing the same lower body shape can share the same advice regarding, for example, trousers.

Fewer profiles may be visible to the customer by grouping profiles with similar attributes into one category.

For example, Butterscotch can be placed on its own in a (presentational) category also called ‘Butterscotch’, which is a narrow straight frame.

Candy Floss and Coconut Ice can be grouped into to a category called ‘Candy Floss’. Candy Floss and Coconut Ice are distinguished by whether the subject is short or long waisted. However, both these profiles are, generally, narrow curvy frames.

Walnut Whip and Turkish Delight can be filtered into a category called ‘Turkish Delight’. Similarly, Walnut Whip and Turkish Delight differ in that one has a short waist or the other has a long waist. Both profiles are generally broad, curvy, light frames. Marshmallow and Sugared Almond can be grouped into a category called ‘Sugared Almond’. Similarly, Marshmallow and Sugared Almond differ in that one has a short waist or the other has a long waist. However, both these profiles are, generally, broad, curvy, heavy frames. Dolly Mixture can remain as the only profile in a category called ‘Dolly Mixture’ which is a broad barrel frame. Vanilla Fudge can be placed in its own category called ‘Vanilla Fudge’ category which is broad straight frame.

Bon Bon, Jelly Bean and Tutti Frutti can be grouped into category called ‘Tutti Frutti’ which is generally a chunky ‘A’ frame. Again, these can be resolved according to height of waist. Honeycomb can be placed in its own category called ‘Honeycomb’ and is light ‘A’ frame. Praline can be placed in its own category called Praline and is a light ‘V’ frame. Finally, Popcorn can be placed in its own category called ‘Popcorn’ and is a chunky ‘V’ frame.

Although profiles can be grouped for presentational purposes (i.e. to show to the user), the original profile can still be maintained and stored for garment selection.

I claim:

1. A method, comprising:
presenting a first question which prompts a user to compare width of shoulders and width of hips;
receiving an answer to the first question;
presenting a second question in dependence upon the answer to the first question;
receiving an answer to the second question;
identifying a body shape in dependence upon at least the answers to the first and second questions; and
storing a body shape identifier corresponding to the body shape.

2. The method of claim 1, wherein presenting the first question comprises:
displaying a first page which includes the first question; and and wherein presenting the second question comprises:
displaying a second, different page which includes the second question.

3. The method of claim 1, comprising:
presenting an image of a body shape with the first question; and
in response to receiving the answer to the first question, resenting a revised image of the body shape reflecting the answer.

4. The method of claim 1, comprising:
prompting the user to confirm their answer or to continue before presenting the second question.

5. The method of claim 1, further comprising:
in response to determining that the width of the shoulders is about the same as the width of the hips, obtaining a value of shoulder width or shoulder circumference;
comparing the value with a corresponding predefined value so as to determine whether the shoulders are broad or narrow; and
choosing the second question in dependence upon whether the shoulders are broad or narrow.

6. The method of claim 5, wherein presenting the second question comprises:
in response to determining that the shoulders are narrow, prompting the user to judge an approximate size of a breast;
wherein identifying the body shape includes determining the body shape in dependence upon size of breast.

7. The method of claim 5, wherein presenting the second question comprises:
in response to determining that the shoulders are broad, prompting the user to judge curvature of waist;
wherein identifying the body shape includes determining the body shape in dependence upon the curvature of a waist.

8. The method of claim 7, further comprising:
in response to receiving an answer that the waist is straight, identifying the body shape.

9. The method of claim 7, further comprising:
in response to receiving an answer that the waist curves outwards, identifying the body shape.

10. The method of claim 7, further comprising:
in response to receiving an answer that the waist curves gently inwards, determining height of waist relative to belly button;
wherein identifying the body shape includes determining the body shape in dependence upon the height of waist.

11. The method of claim 1, further comprising:
in response to determining whether the shoulders are narrower than the hips, determining a height of waist relative to a belly button;
wherein identifying the body shape includes determining the body shape in dependence upon the height of waist.

12. The method of claim 1, comprising:
in response to determining whether the shoulders are broader than the hips, prompting the user to judge an approximate size of a breast,
wherein identifying the body shape includes determining the body shape in dependence upon size of breast

13. The method of claim 1, further comprising:
comparing height of a subject to a predetermined height; and
in dependence upon the height falling below the predetermined height, identifying whether the subject is petite and storing a modifier indicative of height.

14. The method of claim 1, comprising:
receiving a value for each of a plurality of different body measurements; wherein identifying the body shape comprises determining the body shape in dependence upon the result of the comparison and at least one body measurement.

15. The method of claim 1, wherein identifying the body shape comprises identifying a body shape of a woman.

16. The method of claim 1, further comprising:
displaying a representation and/or description of the body shape.

17. The method of claim 1, further comprising:
offering garments for sale based upon the body shape.

18. A computer program product comprising a computer readable medium having a computer program stored thereon comprising instructions for performing the method of claim 1 when executed by a processor.

19. Apparatus comprising:
at least one processor; and
memory;
the processor configured:
to present a first question which prompts a user to compare width of shoulders and width of hips;
to receive an answer to the first question;
to present a second question in dependence upon the answer to the first question;
to receive an answer to the second question;
to identify a body shape in dependence upon the answers to the first and second questions; and
to store, in memory, a body shape identifier corresponding to the body shape.

20. Apparatus comprising:
means for presenting a first question which prompts a user to compare width of shoulders and width of hips;
means for receiving an answer to the first question;
means for presenting a second question in dependence upon the answer to the first question;
means for receiving an answer to the second question;
means for identifying a body shape in dependence upon the answers to the first and second questions; and
means for storing a body shape identifier corresponding to the body shape.
